(19) United States
(12) Patent Application Publication
(10) Pub. No.: US 2011/0231359 A1
(43) Pub. Date: Sep. 22, 2011

(54) SYNCHRONIZATION OF RELATIONAL DATABASES WITH OLAP CUBES

(75) Inventors: Mark Lerwich, Indooripilly (AU); James Henry Wilson, Park Ridge South (AU)

(73) Assignee: Zap Holdings Limited, Ternerife (AU)

(21) Appl. No.: 13/122,894

(22) PCT Filed: Oct. 6, 2009
(86) PCT No.: PCT/AU09/01326

§ 371 Date: May 9, 2011

(30) Foreign Application Priority Data
Oct. 7, 2008 (AU) 2008905207

(51) Int. Cl. G06F 7/06; G06F 17/30

(52) U.S. Cl. 707/600; 707/E17.045

(57) ABSTRACT

A method of synchronizing a source system that stores its records in a relational database and defines its own application level security with an OLAP cube, in which the structure of the relational database and cube is modelled to an intermediate representation for the purpose of comparing both structures; the differences between the two models are identified and used to modify the structure of the cube; the modified structure of the cube is used to generate a script for retrieving data from the relational database for insertion into the cube, after which the script is run and the data is inserted into the modified cube. A unique identifier is used for each item in the base system and each system is tagged with the same identifier in the cube.

This invention relates to the preparation of databases for use in B I (Business Intelligence) systems and in particular relates to automatically synchronizing relational databases for source systems such as CRM (Customer Relationship Management) and ERP (Enterprise Resource Planning) with an automatically generated or pre-existing multidimensional representation.

### BACKGROUND TO THE INVENTION

Business Intelligence is a powerful tool for business management and there have been a number of patents addressing the provision of systems for providing it:
U.S. Pat. No. 7,120,629 discloses a business intelligence system for harvesting prospects using an internet based system and the business's databases.
U.S. Pat. No. 7,315,861 discloses a text mining system for business intelligence.
U.S. Pat. No. 7,333,982 discloses a CRM with an integrated database management system which aggregates data into a non relational data store which is accessible via a query processing mechanism.
USA Patent Application 2004/0034615 discloses a drill down BI system that maps a relational database to an OLAP (Online Analytical Processing) cube (a multi-dimensional database optimized for fast retrieval and aggregation of data).
USA Patent Application 2005/0149583 discloses a method of merging data in two different versions of the same database by comparing the two databases' metadata and using a difference algorithm to identify the differences and then develop a metadata exchange strategy to merge the two databases.
USA application 2006/0116859 discloses a method of generating a reporting model for a relational database.
USA Patent application 2007/0022093 discloses an analysis and reporting system for extensible data formats and OLAP cubes by translating them into a common model without needing to create a data warehouse.
Patent application WO 2007/095959 discloses a business intelligence system and a method of generating an OLAP cube from one or more databases which involves forming a data warehouse as part of the method of building the cube.
U.S. Pat. No. 6,477,536 discloses a method of forming a virtual cube for an OLAP server in which metadata is used to define the mappings and dimensions of the cube.

Relational databases for CRM and ERP are usually customized to suit the business needs in particular industries. Although some companies provide cubes that can be used with these databases they do not take account of the customisations that have taken place. To enable BI systems to carry out their analysis a cumbersome and expert-driven process of synchronizing the databases to the analysis cube is needed. The cost of this process is a deterrent to purchasing and implementing BI systems and only large enterprises can justify the costs involved.

It is an object of this invention to provide an automatic method of customizing relational databases for analysis using OLAP cubes.

### BRIEF DESCRIPTION OF THE INVENTION

To this end the present invention provides a method of synchronizing a relational database to an OLAP cube in which
a) the structure of the relational database is modelled to an intermediate representation
b) the structure of the cube is modelled to an intermediate representation that can be compared to the intermediate representation of the relational database
c) the differences between the two models are identified
d) the differences are used to modify the structure of the cube
e) the modified structure of the cube is used to generate a script for retrieving data from the relational database for insertion into the cube
f) the script is run and the data is inserted into the modified cube.

The modified cube is then suitable for use with MDX inquiries of the data.

This system does not require data warehousing. The method enables the relational database to be transformed for business intelligence analysis without requiring expensive and lengthy involvement of IT experts. By running the program regularly any structural changes to the relational database can be identified and incrementally applied to the OLAP cube.

In a preferred embodiment the relational database is a customised Microsoft CRM product and the cube is created for Microsoft SQL Server Analysis Services.

In a first step metadata is used in building the model of the source system. Metadata is data that describes data typically it describes relationships between the different entities in the source database. Each data table in the source system becomes an entity in the internal model. The columns of the table are mapped according to the nature of data held within them.

The metadata of the relational database is used in constructing the initial model because the metadata describes the entities in the source database, their relationships to each other and the security settings of the data. Thus both intermediate models, which are used to compare the content of the source relational database and the cube, model the structure, relationships and security of the data.

Note that:
Both the relational database and the cube are modelled to intermediate representations that can be compared with each other.
The structure of the cube is preferably created or modified using an application programming interface.
A data source view is preferably used to populate the cube with data from the relational database.
A unique identifier is preferably used for each entity in the source system and each entity is tagged with the same identifier in the cube.

The OLAP cube is essential in BI analysis and is often modified to suit particular queries. The tool of this invention ensures that external modifications made to the cube are preserved when the tool is run to update the cube.

In another aspect the invention also provides a method of carrying over the application level security settings of the source system into the cube by creating a set of permissions for each user in the cube security based on the permissions of their roles in the source system's application-level security model.

The simplest possible security model restricts what each user can or cannot do with a particular entity. Typically permissions determine whether a user can create, read, update or delete, otherwise known as CRUD. Managing the permutations of permission lists for large number of users and entities can be an administrative nightmare. However, since many users often share the same or similar permission sets, the concept of a security role is introduced in some applications such as CRM. Permissions are then defined for that role, and users or groups of users are added to or removed from that role as required.

The way security is described, however, depends very much on the context in which it is operating. From a database perspective, security is defined at a fairly low level with respect to individual tables or views. This typically is referred to as a “database security model”. However an application like CRM operates at a much higher level, typically referred to as an “application security model”, and is defined it in terms relevant to the domain, i.e. CRM business units and organizations.

These two security models are created at quite different levels of abstraction, and are not automatically comparable. A key aspect of this invention is that is able to synthesize security defined at the higher application level in CRM and automatically create those lower level synthetic roles to effect the same security outcomes as working within the CRM application when analysing data in the generated OLAP cube.

### DEFINITIONS

The following terms are used in the description of the invention.

CRM

Customer Relationship Management

Cube

A multi-dimensional database optimized for fast retrieval and aggregation of data

DSV

Data Source View—a view of the base system data which maps more naturally to its definition in the cube than the raw data

ERP

Enterprise Resource Planning is an industry term for the broad set of activities supported by multi-module application software that helps a manufacturer or other business manage the important parts of its business, including product planning, parts purchasing, maintaining inventories

MDX

The leading query language for multi-dimensional databases is MDX, which was created to query OLAP databases, and has become widely adopted with the realm of OLAP applications.

OLAP

On Line Analytical Processing systems enable executives to gain insight into data by providing fast, interactive access to a variety of possible views of information.

The following definitions introduce concepts that reflect the multidimensional view and are basic to OLAP.

A “dimension” is a structure that categorizes data. Commonly used dimensions include customer, product, and time. Typically, a dimension is associated with one or more hierarchies. Several distinct dimensions, combined with measures, enable end users to answer business questions. For example, a Time dimension that categorizes data by month helps to answer the question, “Did we sell more widgets in January or June?”

Numeric data is central to analysis, but how it is handled in the invention is dependent on its scale of measurement. There are usually 4 scales of measurement that must be considered:

Numeric data is central to analysis, but how it is handled in the invention is dependent on its scale of measurement. There are usually 4 scales of measurement that must be considered:
Nominal
Ordinal
Interval
Ratio

A “measure” includes data, usually numeric and on a ratio scale, that can be examined and analysed. Typically, one or more dimensions categorize a given measure, and it is described as “dimensioned by” them.

A “hierarchy” is a logical structure that uses ordered levels as a means of organizing dimension members in parent-child relationships. Typically, end users can expand or collapse the hierarchy by drilling down or up on its levels.

A “level” is a position in a hierarchy. For example, a time dimension might have a hierarchy that represents data at the day, month, quarter and year levels.

An “attribute” is a descriptive characteristic of the elements of a dimension that an end user can specify to select data. For example, end users might choose products using a colour attribute. In this instance, the colour attribute is being used as an “axis of aggregation”. Some attributes can represent keys or relationships into other tables.

A “query” is a specification for a particular set of data, which is referred to as the query's result set. The specification requires selecting, aggregating, calculating or otherwise manipulating data. If such manipulation is required, it is an intrinsic part of the query.

“Metadata” is a key concept involved in this invention. Metadata is essentially data about data. It is information describing the entities in a database (either relational or multidimensional). It also contains information on the relationship between these entities and the security information detailing what information users are permitted to see.

### DETAILED DESCRIPTION OF THE INVENTION

A preferred embodiment of the invention will be described with reference to the drawings in which:

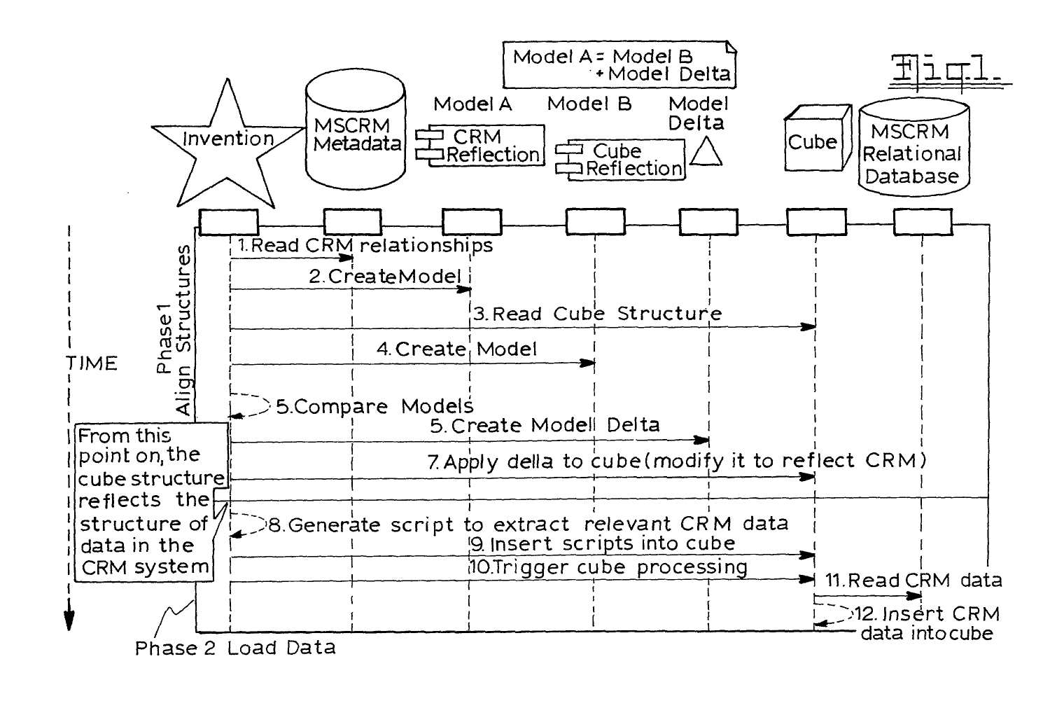

FIG. 1 is a schematic outline of the system of this invention;

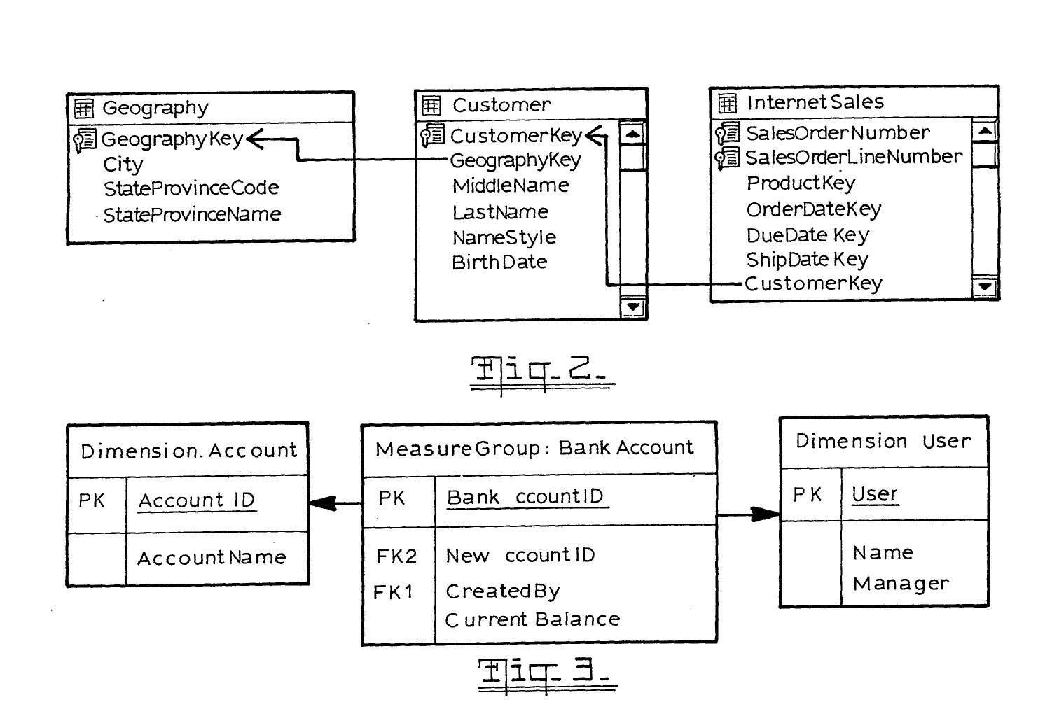

FIG. 2 illustrates schematically the relation ship between a measure group (Internet Sales) and two dimensions (Customer and Geography);

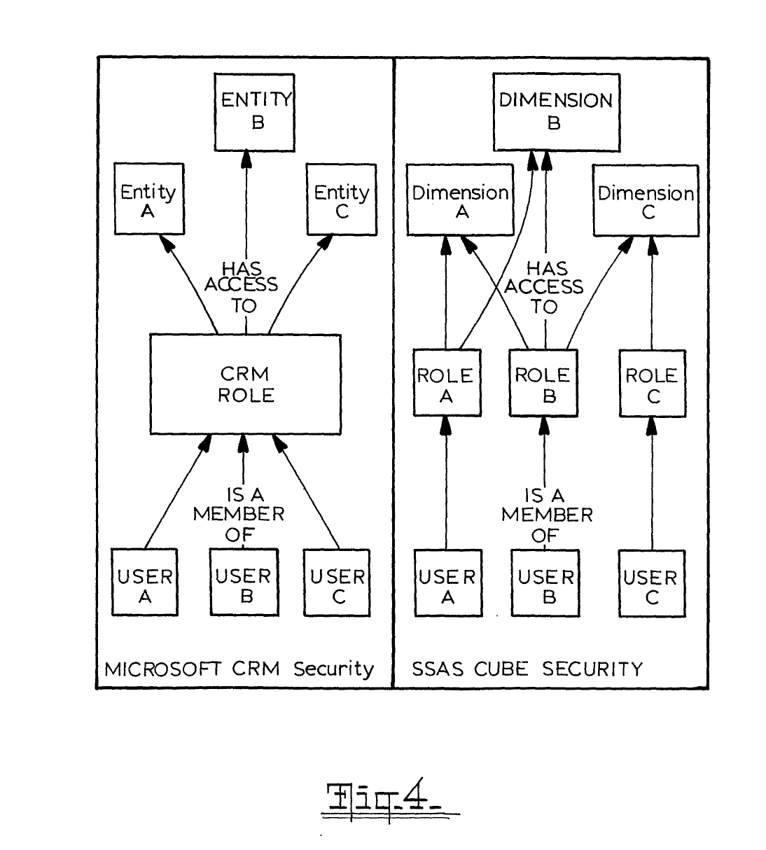

FIG. 3 illustrates schematically the relationship between a measure group (Bank Account) and two dimensions (Account ID and User);

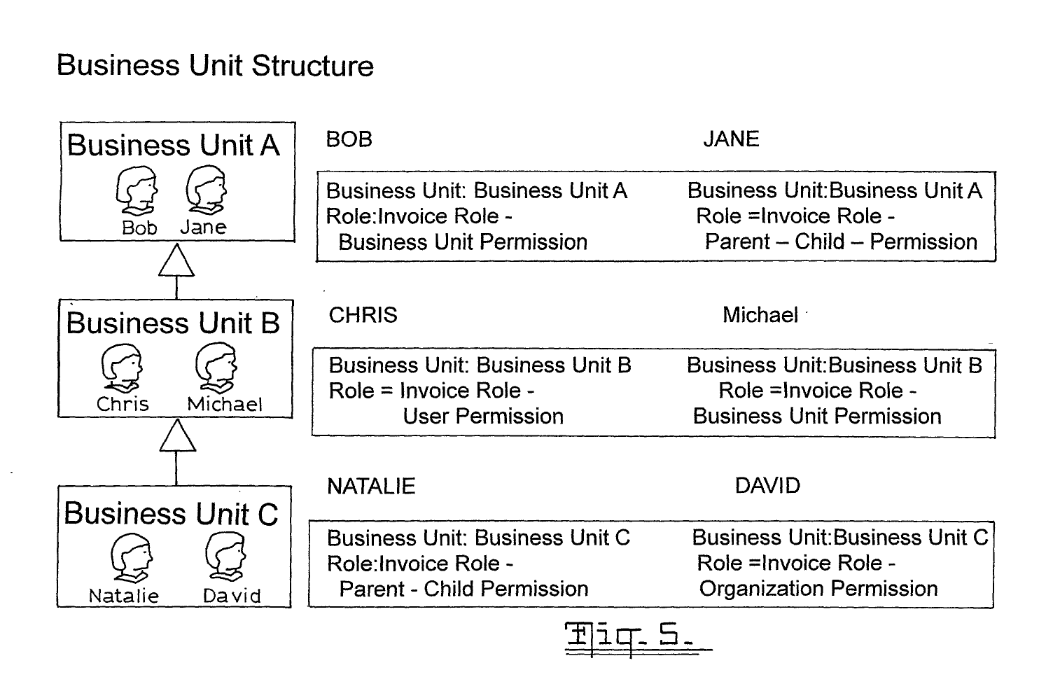

FIG. 4 schematically illustrates the security relationships within a CRM and a Cube;

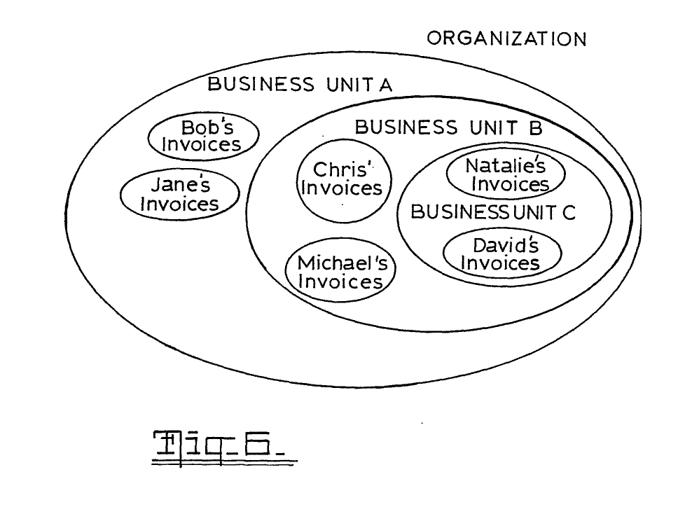

FIG. 5 illustrates a business unit structure for security within a CRM database;

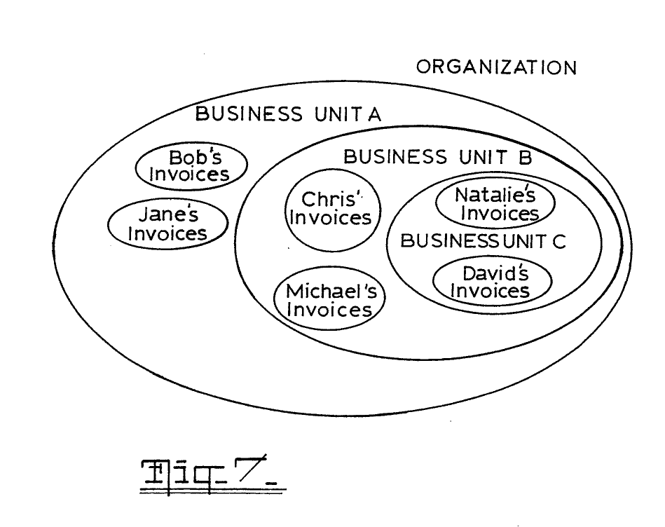

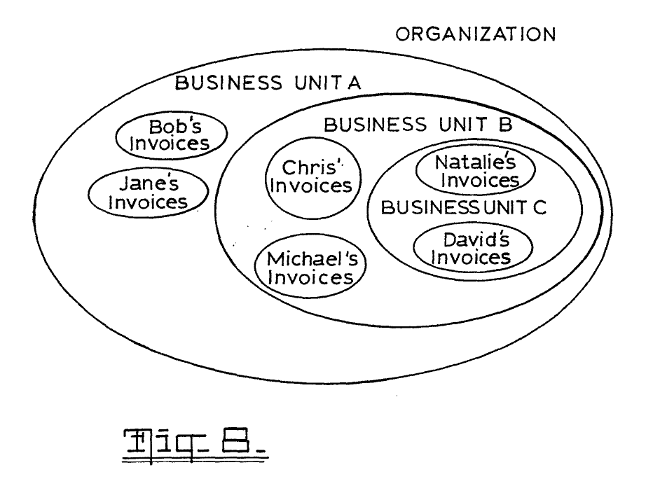

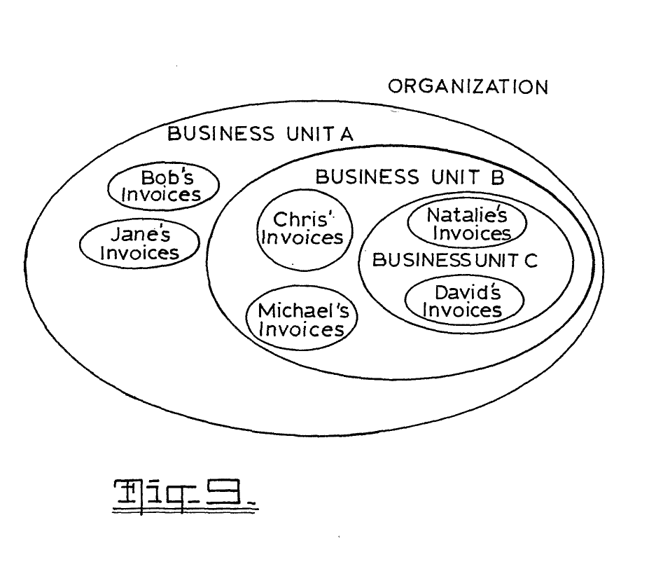

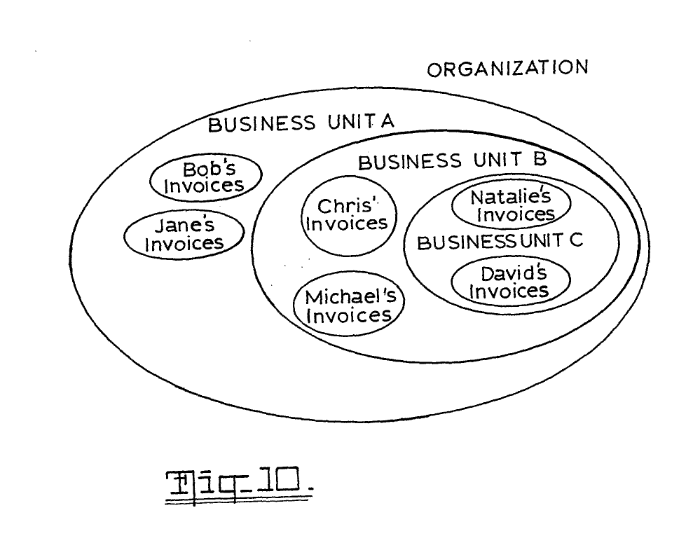

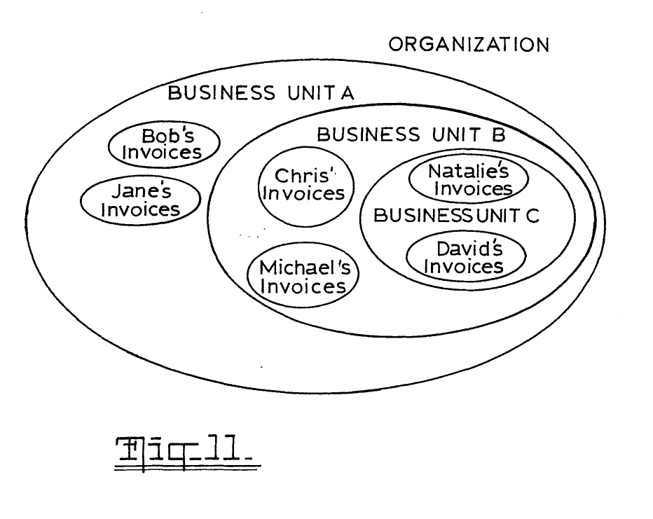

FIGS. 6 to 11 illustrate the roles by which these security settings are represented in the CRM application.

The following example illustrates certain aspects of the invention as they would apply when used with Microsoft's CRM software and Microsoft SQL Server Analysis Services.

The process embodied by the invention is outlined in FIG. 1 and each step as it would pertain to operation with Microsoft's CRM software is annotated below.

### Step 1—Read Metadata

With Microsoft CRM, all of this metadata is collected by the invention through a series of web service calls.

### Step 2—Create Model A

In order to synchronize the two systems a compatible representation of each to compare them is required. This is described in detail under the headings Representing Structure and Synthesizing Security below.

Step 3—Check Cube for Customizations

Reading the cube metadata is performed though an Application Programming Interface (API) which in this instance is Analysis Management Objects (AMO). The principal reason for this step is to identify aspects of the cube if any, that are external to Model A so they can be preserved.

Step 4—Create Model B

The model built to represent the data by the invention closely resembles the structure of the cube. As a result, converting the cube metadata into Model B for comparison with Model A is a fairly straightforward literal translation.

### Step 5 and 6—Integrate Models and Create Model Delta for Incremental Update

The first time the invention is run, it transforms the data from a relational database to structurally different, multi-dimensional one and creates the cube. Subsequent runs account for the existence of a cube created previously.

This invention accounts for two levels of customization. Not only does it pick up all customizations that have been introduced in the source system (“content customization”) its transformation process also preserves any customizations that have been made to its output cube from a previous run of the invention. These changes are external to Model A.

This approach is further refined to allow for incremental updates for improved performance.

The synchronization (applied at Step 5 in FIG. 1) compares the two models by examining each entity in both models and applying the following rules to build up a model delta:
If the entity x in Model A does not exist in Model B its addition is inserted into the delta
If the entity x does not exist in Model A but it does in Model B its deletion is inserted into the delta
If the entity x in Model A does not match the corresponding entity x in Model B its update is inserted into the delta

### Step 7—Apply Delta to Cube

Armed with the delta, the tool updates the structure of the cube through an Application Programming Interface (API) which in this instance is Analysis Management Objects (AMO).

### Step 8—Generate Data Source View (DSV)

Importantly, the approach of comparing two models and applying the difference to the cube allows for manual changes to be made to the cube (where a different type of analysis is required by the business of the cube) and automatically preserved with the help of two key innovations.

Firstly, a convention is established to create a unique identifier (that can consistently be derived) for each item represented in the base system. This item is then tagged with this same identifier in the cube.

Secondly, the invention builds SQL queries to generate a data source view or DSV which is used in populating the cube. This data source view closely reflects the internal representation outlined above. The queries are structured in a specific manner which allows the tool to work with a manually modified view as long as the conventions are followed.

Starting with the basic structure outlined here as a starting template:

SELECT base.*
FROM
(SELECT

e. ...

) AS base
inner join [CRM View] custom on base.[EntityId] =
custom.[EntityId]

the inventions adds custom fields to a named query based on the user's selection. They are inserted between base.* and from. For example:

SELECT base.*

,custom.CustomField1
,custom.CustomField2
,custom.CustomField3

FROM
(SELECT

e. ...

FROM Account e
) AS base
INNER JOIN Account custom ON base.AccountId = custom.AccountId

Where changes to the cube are required to handle different sorts of analysis, manual changes can be made to the inner select to perform any type of query without affecting the invention's ability to modify the query to add or remove custom fields.

For example, a user might modify their cube with the query below:

SELECT base.*
FROM
(SELECT

e.InvoiceId,
b.Name AS owningbusinessunitname,
t.Name AS owningteamname,
CONVERT(DATETIME, CONVERT(VARCHAR(10),
DATEADD(hh,
DATEDIFF(hh, GETUTCDATE( ), GETDATE( )), e.ModifiedOn),
120)) AS modifiedon
FROM Invoice AS e
LEFT OUTER JOIN BusinessUnit AS b ON e.OwningBusinessUnit

= b.BusinessUnitId

| LEFT OUTER JOIN Team AS t ON e.OwningTeam = t.TeamId | |
|---|---|
| WHERE | (e.DeletionStateCode = 0) |

) AS base
INNER JOIN Invoice AS custom ON custom.InvoiceId =
base.InvoiceId

### Step 9—Update DSV Schema and Extraction Queries

By the time this step is reached, the cube structure has already been aligned with CRM and its customizations. This step is necessary to make sure the customized data is loaded into the cube correctly.

The update to the data source view and extraction queries in the cube is performed though an Application Programming Interface (API) which in this instance is Analysis Management Objects (AMO).

Steps 10, 11 and 12—Trigger Cube Processing, Read Source System Data and Insert Data into Cube

The final step now is to trigger the processing of the cube which in turn takes over responsibility for populating itself with the data from the source system (CRM).

### Representing Structure

Broadly speaking, each table in the source system becomes an entity in the tool's internal model. By querying the metadata, the columns of that table are mapped according to the nature of data held within them.

| Data Type | Mapped To |
|---|---|
| Ratio scale numeric data | Measure |
| Nominal scale numeric data | Attribute Hierarchy |
| Textual data | Attribute |

The mapping of a nominal scale numeric data (numeric encoding of categories) to attribute hierarchies works by creating a one level deep hierarchy where the parent node is named according to the category itself and the child nodes are named according to each possible value in that category.

The other important metadata is that describing relationships between entities.

For each measure group, lists of relationships are stored in the model that relate each group to the relevant dimensions. There are two types of relationships:
A regular relationship is a one-to-many relationship between the measure or group of measures and the dimension. For example, consider relating a customer to an invoice. Each customer is unique, but may have one or more invoices charged against them.
A fact relationship is a one-to-one relationship between a measure group and a dimension. An example of a fact relationship would be a 1:1 relationship between the invoice measure group and the invoice dimension because each invoice is stored only once in the data source view. As a second example consider FIG. 2. It shows a measure group Internet Sales, and two dimension tables called Customer and Geography.

To make matters concrete, Table 1 shows how a Bank Account entity in the CRM system is represented internally in the invention, firstly to facilitate comparison and secondly to closely reflect how that entity will appear in the final multidimensional database (cube). This table is graphically represented in FIG. 3.

TABLE 1
Building “Model A” from Microsoft CRM

| CRM Metadata | Model A |
|---|---|
| Entity: Bank Account | Entity: Bank Account |
| Display Name: Bank Account | Name: Bank Account |
| Name: new_bankaccount | ID: new_bankaccount |
| Type: Custom Entity | IsCustom: True |
| | An entity is represented in the model as a container holding |
| | both a dimension and a measure group. |
| | Dimension: Bank Account |
| | ID: new_bankaccount |
| | Name: Bank Account |
| | Key Column: |
| | New_bankaccount.New_bankaccountId (Guid) |
| Attribute: Bank Account | Attribute: Bank Account |
| Display Name: Bank Account | ID: new_bankaccount |
| Name: new_bankaccountid | Name: Bank Account |
| Type : Primary Key | Key Column: |
| | New_bankaccount.New_bankaccountId |
| | (Guid) |
| | Name Column: |
| | New_bankaccount.new_name (WChar) |
| Attribute: Name | The Bank Account Attribute uses both |
| Display Name: Name | Primary Key and Name attributes from |
| Name: new_name | CRM |
| Type: nvarchar | |
| Attribute: Contact | Lookup fields other than createdby, |
| Display Name: Contact | modifiedby and owningbusinessunit are |
| Name: new_contactId | represented in the model by relationships |
| Type: lookup | |
| Attribute: Overdraft Facility | Attribute: Overdraft Facility |
| Display Name: Overdraft | ID: New_HasOverdraft |
| Facility | Name: Overdraft Facility |
| Name: new_hasoverdraft | Key Column: |
| Type: bit | New_bankaccount.New_HasOverdraft |
| | (Boolean) |
| | Name Column: |
| | New_bankaccount.New_HasOverdraft |
| | (WChar) |
| Attribute: Account Type | Attribute: Account Type |
| Display Name: Account Type | ID: New_AccountType |
| Name: new_accounttype | Name: Account Type |
| Type: picklist | Key Column: New_bankaccount |
| | New_AccountType.AttributeID (Integer) |
| | Name Column: New_bankaccount |
| | New_AccountType.AttributeValue (WChar) |
| | Picklist attributes each have a table in the |
| | DSV that is related to the entity table. This |
| | is done so that each value of the picklist is |
| | listed as a member of the attribute |
| | hierarchy even if they haven't been used |
| | by any records. |
| Attribute: Account Label | Attribute: Account Label |
| Display Name: Account Label | ID: New_AccountLabel |
| Name: new_accountlabel | Name: Account Label |
| Type: nvarchar | Key Column: |
| | New_bankaccount.New_AccountLabel |
| | (WChar) |
| | Name Column: |
| | New_bankaccount.New_AccountLabel |
| | (WChar) |
| Attribute: Account Number | Attribute: Account Number |
| Display Name: Account Number | ID: New_AccountNumber |
| Name: new_accountnumber | Name: Account Number |
| Type: int | Key Column: |
| | New_bankaccount.New_AccountNumber |
| | (Integer) |
| | Name Column: New_bankaccount |
| | New_AccountNumber (WChar) |
| Attribute: Account | Lookup attributes are imported as |
| Display Name: Account | relationships. In this particular example, |
| Name: new_accountid | this attribute can be ignored because the |
| Type: lookup | account attribute from the Account |
| | dimension can be used instead. |
| | Measure Group: BankAccount |
| | ID: new_bankaccount |
| | Name: Bank Account |
| | A measure group is created for the entity if it has |
| | any measures |
| Attribute: Current Balance | Measure: Bank Account Current Balance |
| Display Name: Current Balance | ID: |
| Name: new_currentbalance | new_bankaccount_New_CurrentBalance |
| Type: money | Name: Bank Account Current Balance |
| | Column: New_CurrentBalance (Currency) |
| | Measure: Bank Account Account Number |
| | ID: |
| | new_bankaccount_ New_AccountNumber |
| | Name: Bank Account Account Number |
| | Column: |
| | new_ bankaccount.New_AccountNumber |
| | (Integer) |
| | Integer attributes are modelled as both |
| | Measure and Attributes, because they |
| | could potentially be either or both |
| | depending on business requirements. In |
| | this case account number should be an |
| | attribute and not a measure so the user |
| | should not check the add action against |
| | the Account Number measure. |
| | Relationship: Bank Account |
| | ID: new_bankaccount_new_bankaccountid |
| | Name: Bank Account (new_bankaccountid) |
| | Dimension: Bank Account |
| | Measure Column: new_bankaccountid |
| | Relation Type: Fact |
| | A fact relationship is always created for an |
| | entity to relate its dimension to the its |
| | measure group. |
| Relationship: Account | Relationship: Account (new_accountid) |
| Name: | ID: account_ new_accountid |
| new_account_bankaccount | Name: Account (new_accountid) |
| Primary Entity: Account | Dimension: Account |
| Related Entity: Bank Account | Measure Column: new_accountid |
| Relationship Attribute: Account | Relation Type: Regular |
| Relationship Attribute ID | |
| Type: N:1 | |
| Relationship: User | Relationship: User (createdby) |
| Name: | ID: systemuser_createdby |
| Ik_new_bankaccount_createdby | Name: User (createdby) |
| Primary Entity: User | Dimension: User |
| Related Entity: Bank Account | Measure Column: createdby |
| Relationship Attribute: Created | Relation Type: Regular |
| By | |
| Type: N:1 | |
| Relationship: User | Only one relationship can be created |
| Name: | between a measure group and an entity. |
| Ik_new_bankaccount_createdby | The user is able to choose which |
| Primary Entity: User | relationship is used. |
| Related Entity: Bank Account | |
| Relationship Attribute: Created | |
| By | |
| Type: N:1 | |
| Relationship: Task | Only many-to-one relationships are |
| Name: | imported. A relationship will be created |
| new_bankaccount_Tasks | from the Task measure group. |
| Primary Entity: Bank Account | |
| Related Entity: Task | |
| Relationship Attribute: | |
| Regarding | |
| Type: 1:N | |

### Synthesizing Security

A key aspect of this invention is its ability to recreate the security settings of the source system in the OLAP cube. This is achievable even when the source system's security model is incompatible with the OLAP system's because a translation layer that can synthesize any security model in the cube is introduced.

To make matters concrete, we will now discuss how this mechanism works with Microsoft CRM as the source system.

Microsoft CRM has five levels of permissions for users, which we will respect for users migrated to the target Cube. Each level inherits the permissions of the role prior to it.
1. None Selected—User has no permissions; cannot access any entity.
2. Owner—User only has access to a small sub-section of records—those that they own (e.g. have created), those that have been explicitly shared with them, and those that have been made available to any team of which they are a member.
3. Business Unit—Users with this role have access to all entities within their containing business unit. Users do not have access to entities within any other business unit.
4. Parent:Child Business Units—User has access to entities within their own business unit, and also to entities in any business unit that is a child of the user's business unit. So if the business unit ‘Capital City-Marketing’ is a child of ‘Capital City’, then a user who is part of ‘Capital City’ with this role will have access to entities in both. If the user were a member of ‘Capital City-Marketing’, they would not have access to ‘Capital City’, since it is a parent.
5. Organization—Users with this role have access to all entities within all business units of a defined CRM organization.

As shown in FIG. 4 our target OLAP engine in this instance (SQL Server Analysis Services, or SSAS) does not implement security in the same fashion we need to synthesize this arrangement in the cube. To do this, we create a set of permissions for each user individually (through a SSAS security role), based on the permissions their CRM security role gave them, achieving the goal “What one sees in CRM is what one sees in the cube”.

### Invoice Security Example

The following example covers a variety of security scenarios. For simplicity we are only concerned about the Invoice entity.

Consider an Invoice role that provides read access to invoice records only, according to the CRM permission levels described above.

### CRM Security Setup

Business unit structure is shown in FIG. 5.

For this example, assume 6 fictitious invoices have been created in the system. The owning user and user's business unit are as per the Invoice name.

| | Total |
|---|---|
| Name | Amount |
| Invoice 1-Business Unit A-Bob | $7,776.00 |
| Invoice 2-Business Unit A-Jane | $44,433.00 |
| Invoice 3-BusinesS Unit B-Chris | $4,543.00 |
| Invoice 4-Business Unit B-Michael | $2,323.00 |
| Invoice 5-Buiness Unit C-Natalie | $2,234.00 |
| Invoice 6-Business Unit C-David | $2,343.00 |

As mentioned above, CRM's security reflects an organizational structure, and cube security as it is implemented in SQL Server Analysis Services is a straight role-based implementation, we need to enumerate the permissions of each user into one role per user to guarantee that the appropriate permissions are replicated. These roles are how the security settings are represented in Model A. The role for each employee is shown in FIGS. 6 to 11.

### Cube Security Model

The invention's internal model of security is almost an exact match to the metadata describing security in the cube. However, we need one further key innovation to realize the security described by the model in the cube.

Each role in the model maps directly to a role created in the cube.

In the cube “dimension data access” controls which dimension attributes can be accessed by members of a role. Allowing or denying access to an attribute defines access to levels in the dimension hierarchies based on that attribute. If a role is denied access to an attribute, then it is denied access to all levels derived from the attribute.

For each “Applied To” entry in the model, attribute level security is added to the key attribute of each dimension. This implicitly applies to all attributes in the dimension hierarchy. This is the desired behaviour because each CRM entity is represented by a corresponding dimension in the cube. Furthermore, this is done by generating the appropriate MDX according to the Permission Type of the “Applies To” item in the model:
Organization: No attribute permissions are created against the role.
Owner: The allowed member set expression is set to an MDX query that filters the primary attribute of the dimension using the owner attribute.
Business Unit: The allowed member set expression is set to an MDX query that filters the primary attribute of the dimension using the Owning Business Unit Attribute.
Parent-Child Business Unit: The allowed member set expression is set to an MDX query that filters the primary attribute of the dimension using the Owning Business Unit Attribute. The list of owning business units has already been stored in the model, so are listed explicitly as a set in the MDX rather than being calculated dynamically.
None: The allowed member set expression is set to an MDX query that only specified the “Unknown Member”. This has the effect of a “deny all” without affecting other dimensions.

Finally, to complete the security example, this is how two sample users Bob and Jane's roles in the model look in the cube:

Role name: MSCRM_Cube_Bob
Membership: sbx2k3\testuser1
Permissions: Read definition
Dimension Data:

Dimension: Invoice
Attribute: Invoice
Allowed Member Set:
EXCEPT(UNION(
NONEMPTY([Invoice].[Invoice].MEMBERS,[Invoice].[Owning
Business Unit].&[{552b0d5d-fa7d-dd11-ba74-00155d015b2a}]),
[Invoice].[Invoice].[Unknown]),[Invoice].[Invoice].[All])

Role name: MSCRM_Cube_Jane
Membership: sbx2k3\testuser2
Permissions: Read definition
Dimension Data:

Dimension: Invoice
Attribute: Invoice
Allowed Member Set:
EXCEPT(UNION(
NONEMPTY([Invoice].[Invoice].MEMBERS,[Invoice].[Owning
Business Unit].&[{552b0d5d-fa7d-dd11-ba74-00155d015b2a}]),
NONEMPTY([Invoice].[Invoice].MEMBERS,[Invoice].[Owning
Business Unit].&[{562b0d5d-fa7d-dd11-ba74-00155d015b2a}]),
NONEMPTY([Invoice].[Invoice].MEMBERS,[Invoice].[Owning
Business Unit].&[{572b0d5d-fa7d-dd11-ba74-00155d015b2a}]),

[Invoice].[Invoice].[Unknown]),[Invoice].[Invoice].[All])

Now, when these same CRM users interrogate the cube with an OLAP reporting tool, what they see in CRM is precisely reflected by what they are able to see in the cube. The method just described will map two completely disparate security models to each other with complete fidelity, but it can introduce some scalability issues with large user counts. Another approach creates a single role for each role in the source system and users are members of those roles also as defined in the source system. Security is defined on the highest granularity attributes (the top level defined in the hierarchy). For example, for the Owner dimension in CRM, this would be the Business Unit attribute.

To implement this method, the following calculated members and sets would be created in the cube for our CRM example:

[Owner].[Login].[Me]

//The current user
CREATE MEMBER CURRENTCUBE.[Owner].[Login].[Me]
AS StrToMember(‘[Owner].[Login].[‘ + UserName( ) +
’]’);

[My Business Unit]

//The current user's business unit
CREATE SET CURRENTCUBE.[My Business Unit]
AS
NONEMPTY ([Business Unit].[Business Unit].MEMBERS,

([Owner].[Login].[Me], [Measures].[User Count])) −

[Business Unit].[Business Unit].[All];

[My Business Unit and Descendants]

//The current user's business unit and all of its
descendants
CREATE SET CURRENTCUBE.[My Business Unit and
Descendants]
AS
HIERARCHIZE(DISTINCT( DESCENDANTS(

LinkMember([My Business Unit].Item(0), [Business

Unit].[Parent Business Unit])

)));

These members are used in the attribute security MDX to filter data dynamically according to the current logged on user. This has the following advantages:
Changes to organization structure, or business unit membership only requires a re-process of the cube to take effect
Drastically reduces the amount of security information in the cube
Improves maintainability if manual changes need to be made
These calculated members can also be used in content to automatically filter reports to the current logged on user

The attribute security is defined as follows. This requires that each dimension must have a [Business Unit] and [Owner] attribute. It doesn't require a measure group because we use the LinkSet stored procedure which matches Business Units or users using a simple name match.

Business Unit Permissions (Invoice Example)
// returns the business unit member of the invoice business
unit attribute
DISTINCT(WizardASSP.LinkSet([My Business Unit],
[Invoice].[Owning Business Unit].[Owning Business Unit])) +
[Invoice]].[Business Unit].UNKNOWNMEMBER
Business Unit and Descendant Permissions (Invoice Example)
// returns a set of business unit members of the invoice
business unit attribute
DISTINCT(WizardASSP.LinkSet([My Business Unit],
[Invoice].[Owning Business Unit].[Owning Business Unit])) +
[Invoice]].[Business Unit].UNKNOWNMEMBER
Owner Permissions

// returns an owner member in the invoice owner attribute

DISTINCT(WizardASSP.LinkSet({[Owner].[Login].[Me]},
[Invoice].[Owner].[Owner])) +
[Invoice].[Owner]..UNKNOWNMEMBER
None Permissions

{{[Invoice].[Invoice].[Unknown]}}

These synthesized security roles are added to our “Model Delta” as required.

The report Setup is in rows and columns.

| | |
|---|---|
| Rows | [Invoice].[Name].Children |
| Columns | [Measures].[Invoice].[Invoice Total Amount] |

The report results would appear as in the following table.

| | | Invoice Total Amount |
|---|---|---|
| Bob | [symbol] | $7,776.00 |
| | [symbol] | $44,433.00 |
| Jane | [symbol] | $7,776.00 |
| | [symbol] | $44,433.00 |
| | [symbol] | $4,543.00 |
| | [symbol] | $2,323.00 |
| | [symbol] | $2,234.00 |
| | [symbol] | $2,343.00 |
| Chris | [symbol] | $4,543.00 |
| Michael | [symbol] | $4,543.00 |
| | [symbol] | $2,323.00 |
| Natalie | [symbol] | $2,234.00 |
| | [symbol] | $2,343.00 |
| David | [symbol] | $53.03 |
| | [symbol] | $259.26 |
| | [symbol] | $144.84 |
| | [symbol] | $7,776.00 |
| | [symbol] | $44,433.00 |
| | [symbol] | $4,543.00 |
| | [symbol] | $2,323.00 |
| | [symbol] | $2,234.00 |
| | [symbol] | $2,343.00 |
| | [symbol] | $443.26 |
| | [symbol] | $4,601.60 |
| | [symbol] | $223.56 |
| | [symbol] | $393.35 |
| | [symbol] | $34.48 |
| | [symbol] | $73.00 |
| | [symbol] | $2,538.99 |
| | [symbol] | $632.48 |

[symbol]

indicates data missing or illegible when filed

From the above it can be seen that the present invention provides a time and cost saving solution for maintaining correlation between a relational database and its corresponding OLAP cube.

Those skilled in the art will realise that this invention may be implemented in embodiments other than those described without departing from the core teachings of this invention.

1. A computer operable method of synchronizing a relational database to an OLAP cube, in which:
a) the structure of the relational database is modelled to an intermediate representation using a computer;
b) the structure of the cube is modelled to an intermediate representation that can be compared to the intermediate representation of the relational database using a computer;
c) the differences between the two models are identified;
d) the differences are used to modify the structure of the cube;
e) the modified structure of the cube is used to generate a script for retrieving data from the relational database for insertion into the cube;
f) the script is run using a computer and the data is inserted into the modified cube.

2. A method as claimed in claim 1 in which metadata is used to derive a multidimensional model of the relational database.

3. A method as claimed in claim 1 in which the application level security settings of the source system are taken into the cube by creating a set of permissions for each user in the cube security based on the permissions of their security roles in the source system's application-level security model.

4. A method as claimed in claim 1 in which the structure of the cube is modified using an application programming interface.

5. A method as claimed in claim 1 in which a data source view is used to populate the cube with data from the relational database.

6. A method as claimed in claim 5 in which a unique identifier is used for each item in the base system and each item is tagged with the same identifier in the cube.

7. A method as claimed in claim 1 in which external modifications made to the cube are preserved.

8. A computer readable medium encoded with a data structure to synchronize a relational database to an OLAP cube, in which:
a) the structure of the relational database is modelled to an intermediate representation;
b) the structure of the cube is modelled to an intermediate representation that can be compared to the intermediate representation of the relational database;
c) the differences between the two models are identified;
d) the differences are used to modify the structure of the cube;
e) the modified structure of the cube is used to generate a script for retrieving data from the relational database for insertion into the cube;
f) the script is run and the data is inserted into the modified cube.
